(19) United States
(12) Patent Application Publication
(10) Pub. No.: US 2020/0109846 A1
(43) Pub. Date: Apr. 9, 2020

(54) LED wall Assembly with Reconfigurable Supports

(71) Applicant: Production Resource Group, LLC, New Windsor, NY (US)

(72) Inventor: Frederic Opsomer, Kortemark (BE)

(21) Appl. No.: 16/596,202

(22) Filed: Oct. 8, 2019

Related U.S. Application Data
(60) Provisional application No. 62/742,850, filed on Oct. 8, 2018.

(51) Int. Cl. F21V 23/06; H01R 33/94; H01R 33/945

(52) U.S. Cl. CPC F21V 23/06; F21Y 2115/10; H01R 33/945; H01R 33/94

(57) ABSTRACT

A device between connect device for connecting between multiple modular LED structures includes a node, which connects to a modular LED wall, at one end and has the other end which receives power and/or video. In between the first and second ends have a spherical surface. A node linking structure has suction cups that connected the spherical surface and allow changing angles between the different node so that the LED modular devices can have different angles in between them.

### BACKGROUND

A “space frame” is a device formed of a number of different LED panels which each can be separately controlled and powered, and independently configured, e.g., to point in different directions.

Each panel of the space frame is a rectangular LED panel that, once connected, is modular in the sense that it is separately controlled from all other panels.

### SUMMARY

The present application describes a system and method for connecting to and holding, in a flexible way, multiple different modular LED panels.

### BRIEF DESCRIPTION OF THE DRAWINGS

these and other aspects will be described with reference to the accompanying drawings, in which:

FIG. 1 shows a connection between and LED module, a node, and the node linking structure;

FIG. 2 shows a plurality of nodes connected by node linking structures to LEDs law art LED panels connected in a flat configuration; and

FIG. 3 shows the nodes and node linking modes utilizing the ball joint curving to form a curved panel.

### DETAILED DESCRIPTION

The invention can include any or all of LED tiles, with nodes driving the tiles, and node linking structures between the tiles.

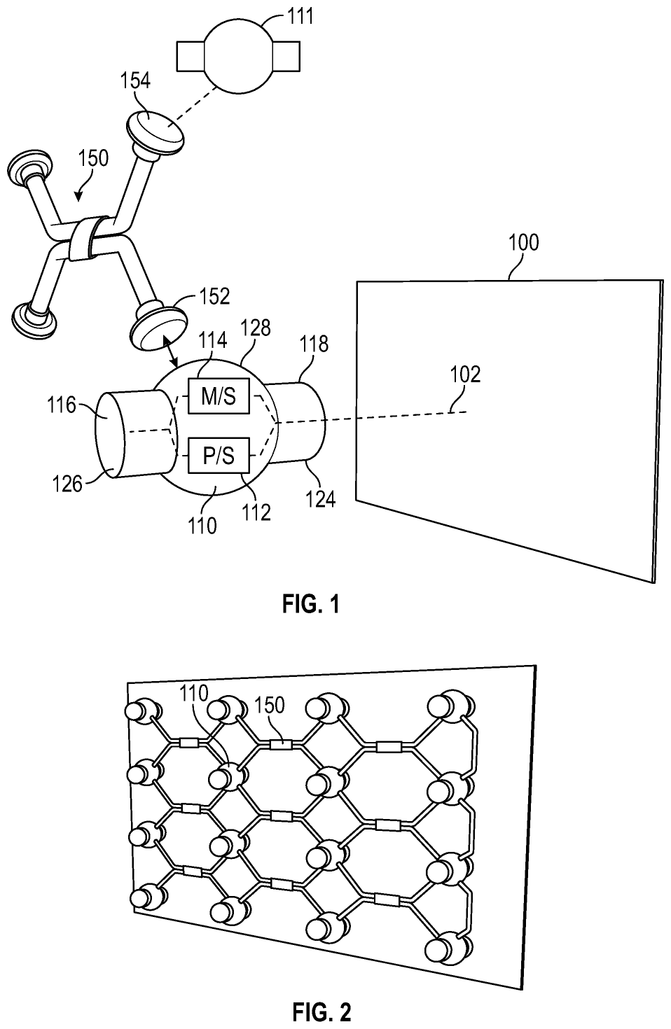

FIG. 1 shows the basic system, where there is an LED panel 100 with a connector 102. The overall wall can be in any shape formed by a number of different LED panels arranged next to each other.

The basic system is shown in FIG. 1, which shows the LED tile 100 connected to a node structure 110, which itself is held by a node linking structure 150. The node is in the shape of two cylinders 124 126, with a rounded ball section 128 in between the two cylinders. One end of the node 118 presses against a corresponding connector 102 on the LED panel. In a similar way, each LED panel can be connected to its own node such as 111.

Each node contains a power supply 112 which receives power and data over cable 116 and also contains a media server 114. The power from the power supply and the information from the media server is connected via the connection between the connector 118 and the connector 102 on the LED panel 100.

The node's rounded body 128 is connected to by a suction cup structure 152 on the node linking structure. The node linking structure is a self-supporting carbon structure having four such suction cups, one at each of four ends, each precisely spaced by the size of the area between different LED structures. As shown, another suction cup device 154 connects to another node 111, which would connect to a different LED panel.

The overall LED wall structure is as shown in FIG. 2 which shows the nodes 110; each node connected to a section of the LED wall structure, held by the node linking structures 150. These enable moving the LED linking structures to any desired position

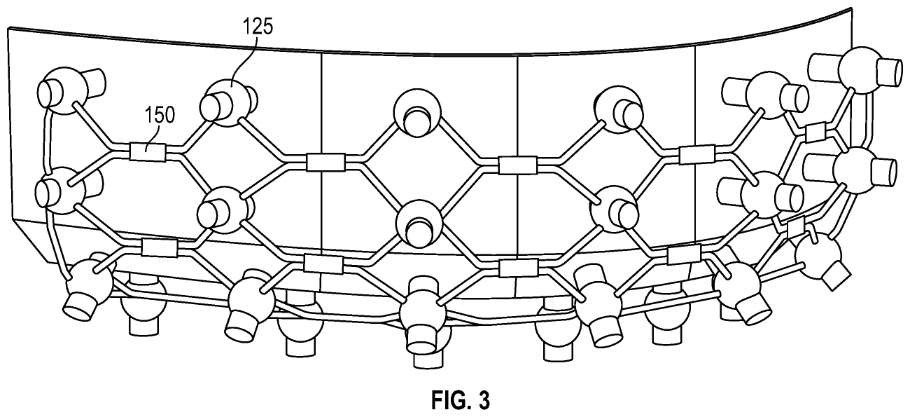

Because the node linking structure is attached on surfaces of the cylindrical shaped section 128 of the node, this enables ball joint curving of the different LED panels relative to one another. As one embodiment, FIG. 3 shows a curved wall, and shows how the node linking structures can attach to different parts on the ball shaped sections 128 of the nodes, to form a curved display. The panels can be connected relative to one another in any desired way.

What is claimed is:

1. A device for connecting between multiple modular LED surfaces, comprising:
a node structure, having a first side for connecting to an LED wall electronically and mechanically, and having another portion, connected to the first side, where the another portion forms at least a section of the spherical surface;
a node linking structure, having for different sphere attaching structures, extending in four different directions, each sphere attaching structure adapted to attach to a node structure, to attach at any location on the node structure's spherical section, to thereby allow varying different angles to exist between each node structure and an adjacent node structure.

2. The device as in claim 1, wherein the node structure includes a power supply therein which provides power to the LED surface.

3. The device as in claim 2, wherein the node structure also includes a media server therein, receiving content, and providing the content to the LED structure.

4. The device as in claim 1, wherein the node linking structure includes 4 arms, which form edge points of the square (add this).

5. The device as in claim 4, wherein the node linking structure includes first and second arms holding first and second suction cup structures, and third and fourth 4th arms holding third and fourth suction cup structures, and a connection part connecting between the first and second arms and the third and fourth arms.

6. The device as in claim 1, wherein the LED tile includes a multipin connector thereon, and the node structure also includes a multipin connector which connects to the multipin connector on the LED tile.
